(19) United States
(12) Patent Application Publication
(10) Pub. No.: US 2015/0048531 A1
(43) Pub. Date: Feb. 19, 2015

(54) AUTOMATED PRODUCTION OF CONCENTRATOR LENS PANELS

(71) Applicant: Orafol Fresnel Optics GmbH, Apolda (DE)

(72) Inventors: Hans Philipp Annen, Berlin (DE); Ralf Leutz, Marburg (DE)

(21) Appl. No.: 14/385,317

(22) PCT Filed: Mar. 5, 2013
(86) PCT No.: PCT/DE2013/000114

§ 371 Date: Sep. 15, 2014

(30) Foreign Application Priority Data
Mar. 14, 2012 (DE) 102012004963.3

(51) Int. Cl. G02B 3/00; B29C 39/04; B29C 39/26

(52) U.S. Cl. CPC G02B 3/0031; B29C 39/265; B29C 39/04; B29L 2011/005
USPC 264/1.1; 425/271

(57) ABSTRACT

The present invention lies in the field of the industrial manufacturing of cast parts and relates to an apparatus and method for the automated production of parts of this type having very fine surface structures, particularly concentrator lens panels, which contain at least one, preferably annular, stepped region as per Fresnel lenses. Handling during the production of the lens panels is difficult, inter alia, because after the curing operation, on account of relatively large adhesion forces or cohesion forces, the mould is removable in a precisely reproducible manner from the product or from the system only with difficulty. It is the object of the present invention to provide a method and an apparatus for the automated production of concentrator lens panels. This is achieved in that a die containing an upper plate (8) and a lower plate (1) initially holds the mould (6) in a precisely defined manner on the upper plate, and the deformable material mass (3) lying on a glass or plastics plate (2) rests in a precisely positioned manner on the lower plate, and then the upper and lower plates are moved together leaving an intermediate space which is evacuated, and the entire sandwich packet is then joined together, kept in a pressed manner and heated until the material is firm. Specially designed securing means (13) then ensure that the sandwich packet can be undone in a reproducible manner and the mould (6) can be separated from the product (9) in a defined manner.

### PRIOR ART

The present invention is in the field of the industrial production of cast parts and relates to an apparatus and to a method for the automated manufacture of such parts having very fine surface structures, in particular concentrator lens panels, which contain at least one stepped region, preferably an annular stepped region, in accordance with Fresnel.

Casting processes form the general prior art in which liquid plastic or silicone is poured into a mold. Usually, the mold (the negative die) is at the bottom, silicone or plastic is poured in and a glass plate is placed on. Hardening subsequently takes place for a long time and under little, or even no, additional pressure for a longer time (hours).

This process is above-all time-intensive for silicone; a large number of molds and large areas are possibly required in the furnace for larger volumes. An automation of these processes is at least partly possible in principle, but is complex and cost-intensive.

Furthermore, silicones have to be outgassed frequently in the process, that is have to lie open under vacuum, before the tool dips into the silicone. This is impossible when casting between the mold and glass.

European patent application EP 2 159 609 A1 forms relevant prior art. The manufacture of concentrator lens panels is disclosed therein, wherein low-shrinkage silicone is mixed with a catalyst containing platinum and is cast onto the surface of a negative die.

The negative die was produced previously and serves as a master mold for the manufacture of the lens panels. Once this mixture has been cast onto the mold in liquid form, a silicon glass panel is placed onto the liquid mixture and pressed onto the mixture for so long until the silicone mixture evenly fills out the surface of the negative die and the silicone mixture forms a layer thickness between the glass and the die of approximately 0.1 to 0.2 millimeters. The silicone mixture subsequently polymerizes at a temperature of 40° Celsius in the course of 20 hours.

After polymerization has taken place, the glass is separated from the negative die in that the die is bent. The silicone-coated glass panel is thus exposed and has the surface structure typical for Fresnel lenses with the annular stepped regions on its surface.

This process is not suitable to be able to carry out a highly efficient production of such lens panels in an automated manner at a larger scale. The reason for the lack of automation capability in the prior art is that the handling of the liquid silicone, the venting of the silicone (liquid silicone contains gas which has to be discharged gradually from the liquid phase) and the geometrical precision of the lens panels of approximately 0.1 millimeters tolerance in the longitudinal direction and in the lateral direction in particular required for large plants can up to now only be carried out manually. Such a low tolerance is produced in that lens panels are always used lying next to one another in an assembly in a larger plant. The lens panels have to be produced with extreme precision so that the optical imaging of the lens panel remains exact.

The handling in the production of the lens panels is inter alia difficult because the mold can only be removed from the product or from the plant exactly reproducibly only with difficulty due to relatively large adhesion forces after the hardening process.

It is the object of the present invention to provide a method and an apparatus for the manufacture of concentrator lens panels which can be automated.

The subject matter having the features of claim 1 and the subject matter of the independent claim achieve this object. The solution comprises, in a summarized and general representation, the fact that a tool containing an upper plate and a lower plate initially holds the mold in a precisely defined manner at the upper plate, that the deformable material compound lies in an exact position on the lower plate lying on a glass or plastic plate and that the upper plate and lower plate are moved toward one another leaving an intermediate space which is evacuated and that the whole sandwich packet is then joined together, held in a pressed manner and heated until the material is solid. Especially configured holding means then ensure that the sandwich packet can be undone in a reproducible manner and that the mold can be separated from the product in a defined manner.

All steps can thereby be carried out by robots. The automated gripping of the mold by robots is in particular possible without either the product or the upper plate remaining stuck to the mold. The automated cleaning of the mold before the next pressing process as well as an automatic replacement of the mold after e.g. 1000 pressing processes are therefore also possible. The process thereby becomes able to be reliably automated in its entirety.

Advantageous further developments and improvements of the respective subject matter of the invention can be found in the respective dependent claims.

### ADVANTAGES OF THE INVENTION

Reference is made to the claims in the following.

I) In accordance with a particular embodiment of the invention, in a production of silicone-on-glass concentrator lens panels, a glass plate which is a component of the product once the production has been completed is placed onto the lower plate and is exactly positioned there relative to the lower plate.

The lower plate of the production tool in accordance with the invention described herein and the upper plate are preferably composed of solid stainless steel of a thickness of approximately 8-30 millimeters or are built up by other measures such as by a very rigid stiffening such that they deflect only minimally even after a long period of use when they are located in a horizontal position. This is necessary so that the degassing process works without contact between the mold and the liquid silicone and the mold which is preferably connected to the upper plate in the manufacturing process dips into the liquid silicone with a very exact definition.

So that the liquid material, which becomes the product or part of the product after solidification, cannot flow off over the rim of the plate after pouring onto the glass plate or on the bottom plate, a retention means is provided in the form of a peripheral seal which surrounds the glass plate like a frame. If work should be carried out without a glass plate, this sealing element surrounds the lower plate in a corresponding manner. This can be intentional in special cases in order, for example, to manufacture dies for test purposes. It must be ensured in this respect that the silicone is not permanently connected to the lower plate.

The mold representing the tool is preferably flexible so that it can be “peeled”, so-to-say “rolled off”, from the silicone material after the solidification of the silicone. This is recommended so that the mold and the product can be separated from one another in a non-destructive manner.

In accordance with a special aspect of the present invention, the mold is connected to the upper plate at an exact position at the start of the process. Then the complete upper plate together with the mold is moved toward the lower plate together with the liquid silicone phase for the evacuation of the space between the mold and the deformable lens material. Spring elements are preferably provided as spacers for this purpose which determine the maximum approximation and which preferably hold the weight of the upper tool (plate+mold) in a distributed manner around the margin of the upper plate and of the lower plate so that the mold and the liquid phase initially do not touch. The upper plate and the lower plate in this state form a unit which can be traveled into a furnace whose interior space can be evacuated, for example, in the automated manufacturing process.

A pressing apparatus is furthermore preferably provided in this furnace which can overpress the aforesaid springs or other flexible elements which have maintained the required spacing between the mold and the liquid phase on the evaluation, and indeed so far until the mold can dip—with a vacuum present—down to the desired dipping depth into the liquid phase. In this process, the relief edges of the mold projecting downward and being present in multiple form do not penetrate the total liquid silicone, but rather leave a residual distance of approximately 0.1 to 1.0 millimeters. Due to the vacuum, there are no air inclusions which would otherwise be caused on the dipping itself.

The total sandwich-like structure of lower plate and upper plate with an interposed mold and liquid silicone is then heated in this state so that the silicone is crosslinked and adopts the known, flexible-solid form whose surface is determined by the surface relief of the mold. The silicone is sufficiently crosslinked and solidified after around 10 minutes and at a process temperature of around 50°-60° Celsius.

This sandwich arrangement can then be opened in that the upper plate is raised from the mold initially remaining on the lower plate. It is necessary for this purpose to make the holding force of the connection means between the upper plate and the mold directly adjustable so that it is smaller than the cohesion forces between the solidified lens material and the mold. Such connection means can, for example, be magnets which form a magnet element in the form of individual disks on top of one another. Sufficiently many of these magnet elements are then distributed over the margin and over the surface of the mold. The mold has corresponding fastening points for the magnets on its rear side, for example, in that a base disk of magnetic material corresponding to the magnet shape is let into the mold or is fastened to the surface of the mold.

II) Alternatively to the above-described manufacturing apparatus and the method associated therewith in accordance with item I), the liquid silicone compound or plastic compound can be cast onto the mold when it lies on the lower plate with the demolding structure upward, preferably after the space above the demolding structure has been evacuated. In this respect, the silicone compound should be as viscous as possible when no evacuation is taking place in order not to cause any permanent air inclusions in the product. A glass plate can then be placed onto the silicone compound, preferably after the space between the liquid silicone and the glass plate has also been evacuated. As described above, the upper plate can afterward then be placed onto the glass plate and can preferably there be fastened by a fastening which is easy to open. The upper plate can then act in a pressing manner on the glass plate, silicone, mold and lower plate and this “sandwich packet” can likewise be exposed to an elevated temperature so that the silicone solidifies and connects to the glass plate.

On the opening of this tool, the mold must then likewise initially remain in the product. This is preferably achieved in that the upper plate together with the product fastened to it consisting of glass plate and solidified silicone, including the mold adhering thereto by cohesion, is raised from the lower plate.

III) The demolding of the workpiece from the mold preferably takes place in both cases of items I) and II) above in that the mold, which can be bent somewhat due to its flexibility, can be raised at a marginal edge, with it being pressed further into the product by correspondingly arranged holding-down means further inward at some distance from the margin so that the mold can then so-to-say be peeled out or rolled off from the product. It is thus ensured that the product can be released from the mold in an automated manner in good order and without damage.

### DRAWINGS

Embodiments of the invention are shown in the drawings and explained in more detail in the following description.

FIG. 1 schematically shows the sandwich-like structure of material parts of the production tool, including the mold and product in an exploded, laterally offset manner of representation in a view from above;

FIG. 2 shows in a partly sectional representation a first step of the production method, wherein liquid silicone material is applied to a glass plate which in turn lies on the lower plate of the production tool;

FIG. 3 likewise shows in a lateral part section the situation of FIG. 2, with a mold generally being brought closer from above, the mold in turn being fastened to the upper plate by magnets;

FIG. 4 likewise shows in a lateral part section representation the situation of FIG. 3 according to which the mold is dipped into the liquid phase of the silicone lens material;

FIG. 5 shows the situation after the opening of the production tool in accordance with the invention likewise in a lateral part sectional representation, with the mold, including the magnets, remaining in the product and the upper plate having been pulled away upwardly;

FIG. 6 likewise shows schematically in a lateral part sectional representation how the mold is peeled out of the product; and

FIGS. 7A), 7B), 7C) show in a schematic side view a tool in accordance with the invention which can preferably be used for the automatic peeling of the mold out of the product.

### DESCRIPTION OF THE EMBODIMENTS

The same reference numerals in the Figures designate the same or functionally the same components.

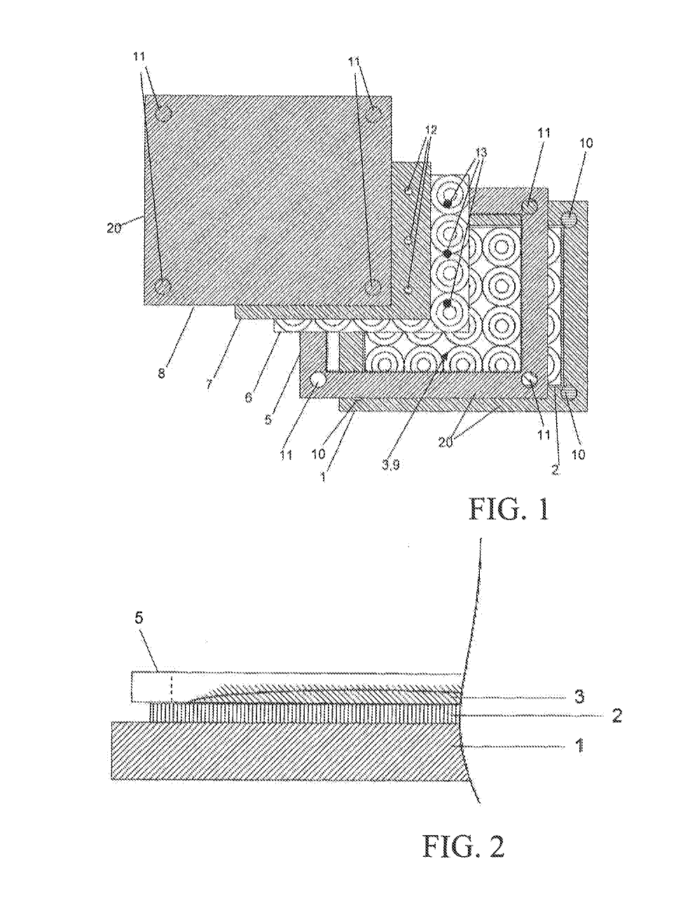

FIG. 1 schematically shows a sandwich-like structure selected as an example of material parts of the production tool, including the mold 6 and the product 9, in an exploded, laterally offset manner of representation in a view from above.

The sandwich-like structure of a production tool in accordance with the invention shown in FIG. 1 for the manufacture of concentrator lens panels is preferably supported on a rack for the carrying out of the first steps of the production method in accordance with the invention, wherein the liquid silicone material is applied to a glass plate which acts as a carrier (material) for the silicone, said rack being set up in stand-alone manner so that one or more robots can handle individual parts of the sandwich-like structure.

In detail, the production tool shown contains in its sandwich-like structure, viewed from bottom to top, first a lower plate 1 of solid stainless steel and having a thickness of around one centimeter, which is a little wider and longer than the associated mold. A lateral overhang in all directions therefore results with a strip width of around five to seven centimeters. Different, mechanically active functional elements which serve the exact positioning of the further articles arranged above the lower plate 1 are attached to these marginal strips, which are marked by reference numeral 20, present on all four margins of the plate.

Furthermore, certain space-maintaining elements 10, 11, 12 are provided on the upper plate and on the lower plate and ensure exactly the right distance between the upper plate 8 and the lower plate 1 or between the mold 6 and the lens material 3 for the different steps of the production method. These elements are preferably helical springs 11 which are each led around a pin 10 which is, for example, screwed to the lower plate and the helical spring are dimensioned in their length such that they act as spacers for the upper plate 8 when the upper plate and the lower plate are pressed onto one another and a pin 10 respectively comes to lie with a firm fit in a corresponding recess 12 of the same shape in the upper plate.

At the start of the production method, a glass plate 2 is placed onto the lower plate 1 and acts as a carrier material for the liquid silicone material 3 which is to be pressed by a mold 6 in the further course of the method and should receive the known Fresnel lens structure.

A sealing frame 5 extends at the transition between the marginal strip 20 and the glass plate 2; it forms a closed rectangle and prevents the liquid silicone material from being able to run off to the outside over the margin of the glass plate after it has been applied to the glass plate in liquid form. The lens material 3 is no longer shown as a liquid phase in FIG. 1, but as a solid and flexible material such as is known as silicone in the crosslinked state. The drawing of FIG. 1 is therefore to be considered as after a completed manufacturing process—but only schematically and showing the basic structure of the sandwich packet.

The mold 6 contains the typical structure of the Fresnel lenses to be deformed in a row/column structure in which four Fresnel lines are present per row and four Fresnel lenses are present per column. In this example, a total width and a total length are produced of approximately 48 centimeters for the mold. The mold has a thickness of approximately 2 to 5 millimeters.

The mold 6 has a plurality of magnets 13 attached distributed over the surface and fastened to its upward facing rear side; the magnets have a round cross-section, and thus a cylindrical shape, with a height which is sufficiently large so that these cylindrical magnets extend through corresponding cut-outs 12 in a non-magnetic spacer plate 4 and establish attraction to the upper plate 8 arranged above the spacer plate 4.

Since the upper plate 8 likewise comprises magnetically attractive stainless steel, the mold 6 adheres via the interposed spacer plate 4 to the upper plate 8 even when the mold 6 faces downwardly in a vertical direction and the mold plane lies in the horizontal direction, as is the case when the upper plate with the spacer plate disposed thereunder and the mold is moved toward the liquid phase of the silicone at the start of the method. The cylinder height of the magnets is set so that the magnetic attractive force between the total number of the magnets and the upper plate is greater than the weight of the mold and the spacer plate 7. When the mass of the mold 6 and of the spacer plate 7 amounts to six kilograms, for example, the cylinder height of the individual magnets distributed over the surface is set such that it exceeds the weight of the mold 6 and the spacer plate by around 20%, that is lies at around 72 N. It is thus ensured that the mold 6 remains firmly connected to the upper plate 8 on the lowering onto the liquid phase of the lens material.

The lens material 3 and the carrier material 2 can be one and the same material, for example liquid, or solidified silicone. This then produces a monolithic product after the crosslinking.

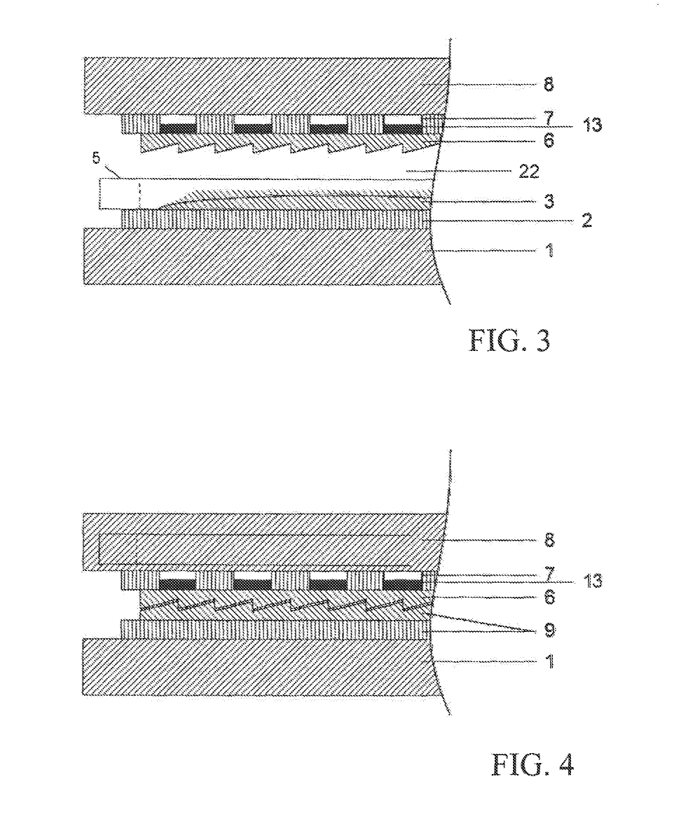

The pins 10 located at the lower plate 1 are lightly conical and dip into the corresponding cutouts 11 in the sealing frame 5 of the upper plate on the approximating of the two plates, as is shown in FIGS. 3 and 4, and provide an exactly fitting seat in the upper plate 8 when the mold 6 has dipped completely into the liquid silicone compound.

Together with a similarly configured positioning of the mold 6 and of the spacer plate 7 with respect to the upper plate 8 and together with a correspondingly exactly configured positioning of the glass plate 2 on the lower plate 1, it thus results that the upper plate can be pushed onto the lower plate with an exact fit and the interposed plates, including the mold and the glass plate, are in this respect positioned with an exact fit with respect to one another.

Further fitting crosses or other guide elements can serve for additional security in the positioning which can be arranged at the marginal strips 20 or which can also be arranged in the interior of the surface of the mold, preferably in the marginal regions of Fresnel lenses so that their optical imaging capability is not impaired.

The shown sandwich-like structure of a production tool in accordance with the invention has a stable construction in material and structure which make this production tool usable in the most varied environments which are typical for such molding processes, that is in particular at elevated temperatures and pressures.

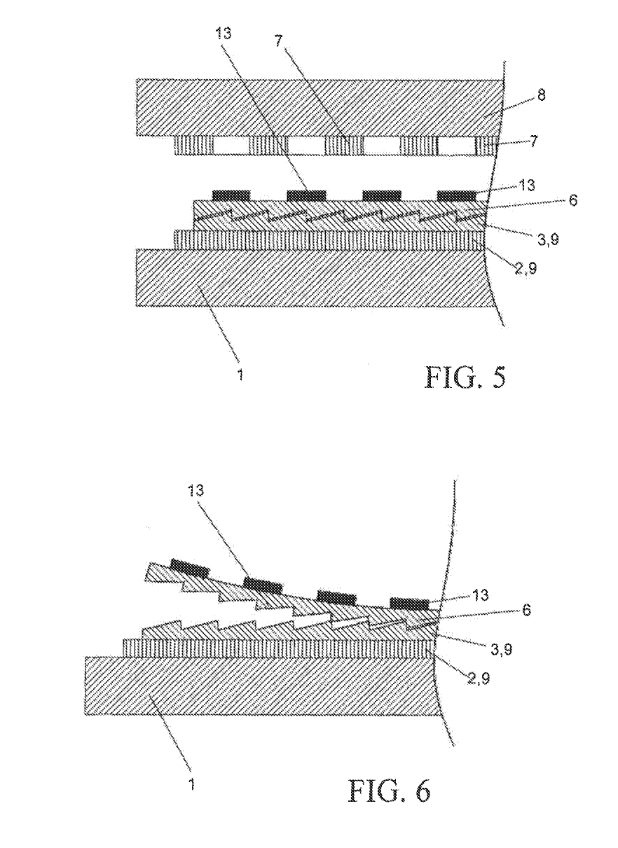

In accordance with a special aspect of the present invention, a releasable connection between the mold 6 and the upper plate 8 is provided which is configured in the shown embodiment by one or more permanent magnets 13 and by corresponding magnetic counter-pieces in a manner such that
on the one hand, the mold 6 remains at the upper plate 8 against gravity when the mold 6 and the upper plate 8 are placed on one another and are aligned exactly there;
on the other hand, the mold 6 remains at the product 9 due to the cohesion forces present between the mold and the product after the mold has molded the product and the lower plate 1 and the upper plate 8 have reestablished their increased spacing on the opening of the production tool, cf. FIG. 5.

In this respect, the number, the arrangement and the holding force of the magnets are selected such that the mold 6 reliably adopts its position in relation to the upper plate and at the product 9 during a molding process.

Provision is also made in this respect that the cut-outs 12 or the holes 12 in the spacer plate 7 for the magnets 13 and optionally for their counter-pieces have been introduced on the rear side of the mold 6 and that the holding force of the magnets 13 has been selected such that the mold 6 can reliably adopt and maintain its position in relation to the upper plate 8 and at the product 9 during a molding process.

In an alternative manner, the magnets 13 or their counter-pieces can also be introduced in cut-outs of the mold 6 or in cut-outs of the upper plate 8 if the spacer plate 7 is to be particularly thin or is to be completely omitted.

These measures ensure that no additional active and passive measures have to be taken to assist the adopting of the position of the mold 6 or to monitor its position such as is often necessary in the prior art, for instance, when a high precision of the products is to be achieved with only small component tolerances. Substantial efforts are required here in the prior art, for example a continuous visual monitoring by staff, carried out via cameras and corresponding monitors.

In the following an exemplary inventive manufacturing process for a concentrator lens panel will be described in more detail with reference to FIGS. 2 to 6.

FIG. 2 shows in a partly sectional representation a first step of the production method, wherein liquid silicone material 3 is applied to a glass plate 2 which in turn lies on the lower plate 1 of the production tool.

First, a glass plate 2 serving as a carrier material for the liquid silicone compound 3 is placed onto the lower plate 2 by robot and is aligned exactly there via the above-described positioning devices. The lower plate 1 for this purpose preferably has guide webs at three of the four corners which extent perpendicular to one another and into which the glass plate is placed coming from the free corner. This work process can also be carried out by robots.

The aforesaid sealing frame 5 is then placed on, likewise by a robot, is positioned in an analog manner and is optionally fixed by one or more snap-in connections, not shown, to the lower plate or to the glass plate.

The liquid lens material 3, for example liquid silicone, is then distributed areally over the glass plate mixed with a crosslinking catalyst in the correspondingly intended quantity by a corresponding dispensing device so that a liquid or pasty film of approximately constant thickness is achieved distributed over the surface. This is likewise done by robot using a pouring or injection tool. The situation shown in FIG. 2 thus results.

FIG. 3 likewise shows in a lateral part section the situation of FIG. 2, with a mold 6 being brought closer from above, the mold in turn being fastened to the upper plate 8 by magnets 13.

For this purpose, the mold 6 is picked up by a robot at its magnetic cylinders 13 firmly fastened thereto after it has been cleaned for the process by robot, with the spacer plate 7 already lying on the rear side of the mold 6 and is laid with placed-on spacer plate 7 onto the upper plate 8, is held firmly there by the attraction force of the magnets and is positioned relative to the upper plate 8.

This positioning preferably takes place in that the spacer plate 7 likewise has guide elements at its side facing the upper plate which likewise contact corresponding guide elements provided on the upper plate with aligned edges when they are exactly aligned with one another. This can take place in an analog manner with the above-described positioning, likewise by robot. A positioning is in particular possible, even when the spacer plate 7 of the mold 6 is only held at the upper plate 8 by the holding force of the magnets 13 against the action of gravity.

The production tool is then closed in that the upper sandwich part comprising the upper plate 8, the spacer plate 7 and the mold 6 is slowly moved toward the lower sandwich structure comprising the lower plate 1, the carrier plate 2 and liquid silicone 3, with the aforesaid pins 10 fitting into the corresponding cut-outs or holes 11 or 12 respectively and being guided therein (cf. FIG. 1).

A certain desired spacing is initially maintained in this respect of, for example 3 mm height difference between the mold surface and the liquid silicone surface, said desired spacing being evacuated in the subsequent evacuation step. The space to be evacuated is in particular provided with the reference numeral 22. The space 22 is maintained by spacers in the form of springs which are pushed over the aforesaid pins 10. These springs can later be overpressed by a corresponding pressing apparatus when the plates are further pressed together to allow the mold to dip into the liquid phase of the silicone.

FIG. 4 likewise shows in a lateral part sectional representation the situation which follows on from the situation of FIG. 3 after the mold 6 has been dipped into the liquid phase of the silicone lens materials and this has solidified and has thereby been connected to the glass plate lying thereunder to form a product 9.

This preferably takes place in detail as follows:

Once the sandwich-like production tool structure in accordance with FIG. 3 has been evacuated in the closed state so that the space 22 is empty of air, the upper plate 8 is pressed even further against the lower plate 1 against the action of the aforesaid springs already active for spacing in the situation of FIG. 3 until a desired position with a minimal spacing of the two plates 1 and 8 with respect to one another is reached which is fixed via abutment elements. The springs are therefore “overpressed”. This maximum approximation of the two plates has the effect that the mold 6 dips completely into the liquid phase of the silicone material up to its desired position and presses the latter material in the desired manner. In this state, the sandwich structure is completely exposed to an elevated temperature, for example 60° C., and indeed for a predefined time period of, for example, 10 minutes, which is selected to be at least so long that the liquid silicone material 3 is sufficiently crosslinked and has transitioned into the solid phase. The liquid lens material 3 is thus laminated onto the glass plate 2, whereby the product 9 arises, a compound material of silicone-on-glass.

For the purposes of evacuation and of the required heating of the liquid silicone phase 3, the sandwich-like tool structure can be brought together as a whole, preferably for the purpose of increasing the efficiency of the production method, simultaneously with a plurality of other sandwich-like structures, which are the same or similar, by a robot into a furnace-like evacuation and pressing apparatus which can also optionally in turn contain the required pressing tools in its interior which are necessary to allow a respective mold 6 to dip into the respective associated liquid silicone phase (pressing over the counter-force of the springs).

In a preferred manner, the furnace-like apparatus therefore contains a hollow space into which one or more sandwich-like structures can be introduced by robot and the entire hollow space can be evacuated, and wherein the plurality of sandwich-like structures can each be pressed individually or together to form a stack so that the molds 6 each dip into the liquid phase up to their desired depth, as is provided by the respective desired minimum spacing between the respective upper plate and lower plate of the structure stack. In this respect, it must be ensured that the process heat provided enters into the liquid silicone as fast as possible.

An expedient embodiment of this apparatus comprises respective heat emission panels which are arranged above one another, which can be heated by current, which are arranged in parallel with one another and can take up between them in each case one respective sandwich-like structure, wherein the heat transition should take place as fast as possible and over the total surface of the respective upper and lower plates. The heat emission panels are pressed toward one another using a hydraulically movable pressing tool until the desired position is reached in each sandwich.

In the next step, the production tool in accordance with the invention is opened, which is shown in FIG. 5. The silicone is crosslinked.

FIG. 5 shows the situation after the opening of the production tool in accordance with the invention likewise in a lateral part sectional representation, with the mold 6, including the magnets 13, remaining in the product 9 and the upper plate 8 having been pulled away upwardly;

Once the pressure overpressing the springs of the pressing apparatus optionally present in the heating and evacuation apparatus has been cancelled, the weight of the respective upper plate 8 still presses against the springs, the above-mentioned pins 10 are still located in the corresponding fitting holes with high fitting precision, but the upper plate 8 raises from the mold 6 as the pressing force reduces because the springs again act as spacers and because the force of the magnets 13 is selected such that it is lower than the cohesion forces which hold the mold 6 together in the now finished product 9.

In one of the next part steps, the upper plate 8 together with the spacer plate can now be even further removed from the mold 6 so that a rolling-off demolding process can take place between the mold 6 and the product 9. This is shown in FIG. 6.

FIG. 6 likewise shows schematically in a lateral part sectional representation how the flexible mold 6 is peeled out of the product 9.

In this demolding step, the mold 6 including the magnets 13 fastened thereto is now peeled from the product 9 (peeling). This is preferably done with the aid of a drum-like roll-off tool which is first placed onto the mold 6 by robot such that the axis of the drum—just like the mold 6—lies in a horizontal position, with the drum first preferably lying in the proximity of a margin of the mold on its surface with a slight, sufficient pressure.

The narrow marginal strip of the mold 6 between its marginal edge which has remained free and the drum is now, likewise with the aid of a robot, slightly raised with suction cups by means of a robot and connected to the drum. Then, in a continuously running roll-off process, the drum is moved in parallel with the two oppositely disposed edges of the mold without in this respect changing the level of the drum axis over the mold 6, with the mold 6 being further raised by the suction cups, likewise continuously and at the same speed as the roll-off process. This is continued for so long until the drum has rolled over the end edge disposed opposite the initial edge of the roll-off process. This can take place from both sides when the axis of the drum first lies centrally. A start of the peeling starting from one or more corners of the mold is also conceivable if the drum was placed on accordingly. The last region of the mold 6 is thereby also peeled out.

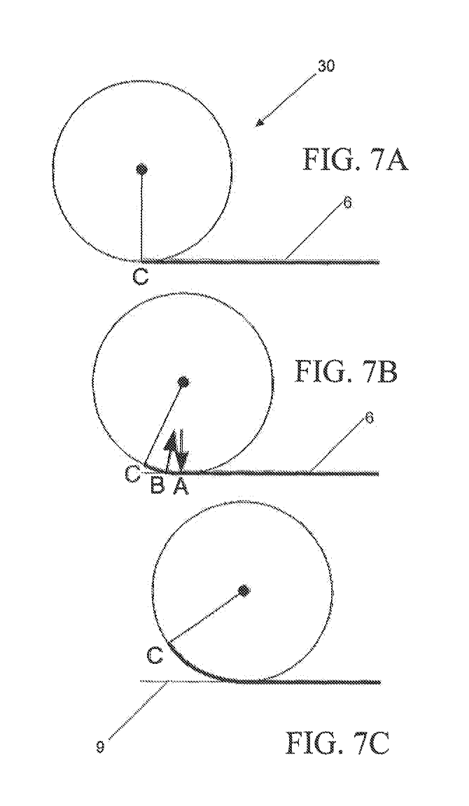

FIG. 7 shows in a schematic side view a tool 30 in accordance with the invention which can preferably be used for the automatic peeling of the mold 6 from the product 9. The tool 30 has a cylindrical shape and is rotatably supported about the cylinder axis. Suction cups are located at is jacket surface which generate a vacuum automatically via a vacuum pump and with sensor control when the drum comes into contact with the rear side of the mold 6.

The suction cups are therefore integrated in the drum and can be evacuated via corresponding air lines and can be pressed onto the rear side of the mold when the drum, as described further above, is placed onto the margin of the mold by robot with parallel edges. Point C shows the foot point/foot line along which the first row of suction cups engages at the rear side of the mold 6. The drum is then only moved in the direction toward the mold center (cf. FIG. 7B), with the margin of the mold already adhering to the drum. The line C is therefore already rolled off and the edge of the mold has been demolded from the product 9, an adjacent line B is just being raised from the bed of the product and line A is the directly adjacent foot line onto which pressure is still being exerted and which still has contact with the product. After a further rolling off, the line C is already lying far above on the jacket surface and the lines B are somewhat lower, but likewise peeled out of the product 9.

This type of demolding ensures with high reliability that neither the mold nor the product is impaired in their quality and functional capability.

After the demolding, the mold can be cleaned in a suitable manner while adhering to the drum in order to be available for the next pressing process and to be able to be positioned right away with the drum by robot for the situation shown in FIG. 2.

Although the present invention has been described with reference to a preferred embodiment above, it is not restricted thereto, but can be modified in a variety of ways.

The thickness of the upper plate and lower plate depends on their deflection and on their availability.

The production apparatus shown and the corresponding method can in particular be used in such molding processes in which the mold 6 and the product 9 may not contact one another in the very first process step, that is if, for example, the interposed space has to be evacuated before the first contact. The same applies to laminating processes. The same likewise applies to processes having carrier materials 2 or product materials 3 to be heated or to be distributed. The same applies to molding processes in which there is a need only to separate the mold 6 from the product 9 after the complete termination of the process, which in particular applies to such cases in which the product 9 is too rigid to be pealed from a likewise rigid mold 6. A flexible mold 6 is used here and allows the demolding of the flexible mold 6 and the product 9 after opening the production tool by peeling.

Measures for supporting the adoption of the position of the mold 6 or of other plates or for the monitoring of their position can be modified in a multiple of ways:

Fitting crosses and similar means and magnets bring the mold into position laterally (x and y directions), as well as non-rotated, and also hold it vertically (z direction) at the upper plate. A positioning tolerance of less than +/−0.5 mm is typically not necessary. This allows the use of robots and of simple portals.

The embodiments of the demolding tools include such examples which mechanically simulate the roll-off movement (mathematically that of a point on the outer radius of a wheel, of a cycloid) without a drum having to be built (for example by means of stroke cylinders or spring plates approximating a circle radius, or similar constructions).

Finally, the features of the dependent claims can be combined with one another substantially freely and not by the order present in the claims, provided that they are independent of one another.

### REFERENCE NUMERAL

1 lower plate
2 carrier material, for example glass plate or silicone plate
3 lens material
4 non-magnetic spacer plate
5 sealing frame
6 mold
7 spacer plate
8 upper plate
9 product
10 pin
11, 12 cut-outs, holes, perforations
13 magnets
20 marginal strip
22 space to be evacuated
30 drum tool

1. A method for the production of a panel representing a workplace, preferably a concentrator lens panel (9), having at least one stepped region, preferably an annular stepped region, in accordance with Fresnel lenses,
characterized by the following steps:
a) loading a lower plate (1) of a production tool, preferably a glass plate (2) or silicone plate lying on the lower plate, with deformable material, preferably lens material, wherein unintended flowing off of the material is prevented by retention means (5) attached to the margin of the lower plate;
b) positioning the lower plate (1), preferably the glass plate (2), with respect to a mold (6), preferably a flexible mold, representing the tool by mechanical positioning means (10, 11, 12), wherein the mold (6) is fastened directly or via an interposed spacer plate (7) to an upper plate (8) of the production tool;
c) bringing the lower plate (1) and the upper plate (8) toward one another, wherein a predefined minimum spacing is maintained between the mold and the deformable lens material (3) by spacer means (10, 11);
d) evacuating the space (22) between the mold (6) and the deformable material (3) in the approximated state of the two plates (1, 8);
e) dipping the mold (6) into the deformable material (3) in the evacuated state for the pressing of the workpiece panel, preferably the concentrator lens panel;
f) hardening the deformable material (3) with a dipped-in mold (6);
g) raising the upper plate (8) from the mold (6), wherein the mold remains in the hardened workpiece (9) in that the holding force of the connection means (13) between the upper plate (8) and the mold (6) is set deliberately smaller than the adhesion forces or cohesion forces between the workpiece (9) and the mold (6); and
h) demolding the workpiece (9) from the mold (6) in that the mold is peeled out of the hardened workpiece (9) by continuously ongoing bending open.

2. A method in accordance with claim 1, wherein, in the positioning step, the mold (6) is releasably and firmly connected to an upper plate (8) corresponding to the lower plate (1) by connection means (13) between the upper plate (8) and the mold (6) whose holding force is provided as adjustable.

3. A method in accordance with claim 1, wherein the holding force of the connection means (13) between the upper plate and the mold is set in that
a) a non-magnetic spacer plate (7) is located between the upper plate (8) and the mold (6) and contains a plurality of cut-outs (12) arranged distributed over the surface of the mold for receiving a corresponding plurality of magnets (13), preferably of permanent magnets;
b) a metallic upper plate (8) is used;
c) the magnets (13), preferably permanent magnets of a predefined strength and size, are provided adhering to the upper plate (8) and in the cut-outs (12) in a spacer plate (7) arranged between the upper plate (8) and the mold (6);
d) the mold (6) has a plurality of magnetic counter-pieces corresponding to the cut-outs (12) in the spacer plate (7), arranged distributed correspondingly over the surface of the mold (6) and fixedly connected to the mold (6); and
e) wherein the strength of the permanent magnets (13) and the spacing of the permanent magnets from the magnetic counter-pieces arranged at the mold are selected such that the mold (6) remains at the upper plate against the action of gravity on the moving of the upper plate (8) toward the lower plate (1), but the mold (6) remains at the hardened workpiece (9) due to the adhesion forces or cohesion forces between the mold (6) and the workpiece (9) when the upper plate (8) is raised.

4. A method in accordance with claim 1, wherein the holding force of the connection means (13) is set between the upper plate (8) and the mold (6) in that, instead of the permanent magnetics, electromagnets are provided which are flowed through by a correspondingly adapted current to set the holding force.

5. A method in accordance with claim 1, wherein positioning elements, preferably cylindrical pins (10) and corresponding cut-outs (12) or fitting crosses and corresponding fitting grooves, as well as abutment elements bounding the spacing of the plates from one another are provided as positioning means attached to the upper plate (8) and lower plate (1), engaging into one another on the moving of the plates toward one another and establishing a firm fit.

6. A method in accordance with claim 1, wherein springs (11) are provided at at least one of the plates (1, 8), said springs compensating the weight of the upper plate when the upper plate (8) is placed onto the lower plate (1) and maintaining a predefined desired distance for venting the space (22) between the mold and the deformable material (3).

7. A method for the production of a panel (9) representing a workpiece, preferably a concentrator lens panel, containing at least one stepped region, preferably an annular stepped region, in accordance with Fresnel lenses, characterized by the following steps:
a) loading mold, preferably a flexible mold, fastened to the lower plate of a production tool directly or via an interposed spacer plate, with deformable material, preferably lens material, wherein unintentional flowing off of the material is prevented by retention means attached to the rim of the lower plate;
b) positioning the mold by mechanical positioning means with respect to a glass plate which is fastened to an upper plate of the production tool;
c) bringing the deformable material, preferably lens material, into contact with the glass plate by moving the upper plate and lower plate toward one another;
d) hardening the material, preferably lens material, with the material being connected to the glass plate and forming the workplace;
e) removing the lower plate, optionally together with the spacer plate, from the mold, with the mold remaining in the hardened workpiece; and
f) demolding the workpiece from the mold in that the mold is peeled out of the hardened workpiece by continuously ongoing bending open.

8. A production tool for the automated production of a panel representing the workpiece, preferably at least one stepped region, preferably a concentrator lens panel containing a preferably annular stepped region, in accordance with Fresnel lenses, the production tool comprising:
a) a device for loading a lower plate (1) of a production tool, preferably a glass plate (2) lying on the lower plate, with deformable material, preferably lens material, having retention means (5) attached to the margin of the lower plate against an unwanted flowing off of the deformable material;
b) a device for positioning the lower plate (1), preferably the glass plate (2), with respect to a mold (6), preferably a flexible mold, representing the tool with respect to one another by mechanical positioning means (10, 12);
c) a device for moving the lower plate (1) and the lower plate (8) toward one another, having spacer means for maintaining a predefined minimum spacing between the mold (6) and the deformable material (3), preferably lens material;
d) a device for evacuating the space (22) between the mold and the deformable lens material (3) in the approximated state of the two plates (1, 8);
e) a device for dipping the mold (6) into the deformable material, preferably into the lens material, for the pressing of the panel (9), or of the concentrator lens panel, in the evacuated state;
f) a device for hardening the material, preferably the lens material, with a dipped-in mold (6);
g) a device for raising the upper plate (8) from the mold (6), with the mold remaining in the hardened workpiece (9), having connection means (13) between the upper plate (8) and the mold (6); and
h) a device (30) for demolding the mold (6) from the workpiece (9), having means for peeling the mold (6) out of the hardened workpiece (9).

9. An apparatus in accordance with claim 8, further comprising adjustment means for setting the holding force of connection means (13) between the upper plate (8) and the mold (6), wherein the mold (6) is releasably and firmly connected to an upper plate (8) corresponding to the lower plate (1).

10. An apparatus in accordance with claim 8, further comprising adjustment means for setting the holding force of the connection means (13) between the upper plate (8) and the mold (6).

11. An apparatus in accordance with claim 10, wherein the adjustment means for setting the holding force of the connection means (13) comprise a non-magnetic spacer plate (7) located between the upper plate and the mold which contains a plurality of cut-outs (12) arranged distributed over the surface of the mold for receiving a corresponding plurality of magnets (13), preferably permanent magnets.

12. An apparatus in accordance with claim 8, comprising a metallic upper plate (8).

13. An apparatus in accordance with claim 8, comprising magnets, preferably permanent magnets (13) of a predefined strength and size, adhering to the upper plate (8) and provided in the cut-outs (12) in a spacer plate (7) arranged between the upper plate (8) and the mold (6).

14. An apparatus in accordance with claim 8, wherein the mold (6) has a plurality of magnetic counter-pieces arranged accordingly distributed over the surface of the mold, fixedly connected to the mold and corresponding to the cut-outs (12) in the spacer plate (7),
wherein the strength of the permanent magnets (13) as well as the space of the permanent magnets from the magnetic counter-pieces arranged at the mold (6) is set such that the mold remains at the upper plate against the effect of gravity on the moving of the upper plate toward the lower plate, but the mold remains at the workpiece on the raising of the upper plate due to the adhesion forces or cohesion forces between the mold (6) and the hardened workpiece (9).

15. An apparatus in accordance with claim 8, wherein positioning elements, preferably cylindrical pins (10) and corresponding cut-outs (12) or fitting crosses and corresponding fitting grooves, as well as abutment elements (10, 12) bounding the spacing of the plates from one another are provided as positioning means attached to the upper plate and lower plate, engaging into one another on the moving of the plates toward one another and establishing a firm fit.

16. An apparatus in accordance with claim 8, wherein springs (11) are provided at at least one of the plates, said springs compensating the weight of the upper plate when the upper plate (8) is placed onto the lower plate (1) and maintaining a predefined desired distance for venting the space (22) between the mold (6) and the deformable material (3).
